(19) United States
(12) Patent Application Publication
(10) Pub. No.: US 2020/0039290 A1
(43) Pub. Date: Feb. 6, 2020

(54) RIGID WHEEL BEARING

(71) Applicant: Schaeffler Technologies AG & Co. KG, Herzogenaurach (DE)

(72) Inventors: Shakeel Shaikh, Windsor (CA); Shawn Leasa, Stratford (CA)

(73) Assignee: Schaeffler Technologies AG & Co. KG, Herzogenaurach (DE)

(21) Appl. No.: 16/051,806

(22) Filed: Aug. 1, 2018

(51) Int. Cl. B60B 27/02; F16C 19/18

(52) U.S. Cl. CPC B60B 27/02; F16C 19/183; F16C 2326/02; B60B 2900/311; B60B 2900/111; B60B 2380/73

(57) ABSTRACT

Wheel bearing flanges and wheel bearings are disclosed. The wheel bearing flange may include a flange connected to an inner ring of a bearing, the flange having a front surface facing away from the inner ring and a rear surface facing towards the inner ring. A plurality of geometric features may extend from the rear surface in an axial direction and define recessed regions of the flange therebetween. The geometric features may be formed in a pattern and the geometric features may include ribs.

### TECHNICAL FIELD

The present disclosure relates generally to a wheel bearing, for example, a rigid wheel bearing for a vehicle.

### BACKGROUND

Bearing assemblies generally include a plurality of rolling elements sandwiched between opposing raceways in bearing rings. The rolling elements may take many forms, such as spherical balls, rollers, tapered rollers, barrel-shaped spherical rollers, or others. Bearing assemblies are used in a wide range of applications. For example, in vehicles, bearing assemblies may be used in wheel bearing assemblies in which they bear a wheel hub that may be driven by a drive element.

### SUMMARY

In at least one embodiment, a wheel bearing flange is provided. The wheel bearing flange may include a flange connected to an inner ring of a bearing, the flange having a front surface facing away from the inner ring and a rear surface facing towards the inner ring. A plurality of geometric features may extend from the rear surface in an axial direction and define recessed regions of the flange therebetween.

In one embodiment, the geometric features are formed in a pattern. The recessed regions of the flange may have a thickness that is from 1-50% or 1-25% of a thickness of the geometric features. The geometric features may include ribs. The ribs may be formed in a pattern around a circumference of the rear surface. In one embodiment, the ribs each include two legs that meet at a vertex. The vertex may be proximate an outer edge of the rear surface. In one embodiment, the vertex forms a portion of a wall surrounding an opening in the flange. The ribs may form a star pattern around a circumference of the rear surface.

The ribs may extend in a direction oblique to a radial direction of the flange. In one embodiment, the flange includes a plurality of spaced apart raised regions having a fastener opening defined therein and one or more ribs are disposed between adjacent raised regions. The one or more ribs may extend from a raised region to an outer edge of the rear surface. The geometric features may include a repeating polygonal pattern. In one embodiment, the repeating polygonal pattern is a honeycomb pattern.

In at least one embodiment, a wheel bearing is provided. The wheel bearing may include an inner ring configured to connect to a wheel of a vehicle and rotate therewith, an outer ring configured to connect to the vehicle and remain stationary, and a flange connected to the inner ring, the flange having a front surface facing the wheel and a rear surface facing away from the wheel. A plurality of rolling elements may be disposed between the inner and outer rings. A plurality of geometric features may extend from the rear surface in an axial direction and define recessed regions of the flange therebetween.

The geometric features may include ribs. In one embodiment, the ribs each include two legs that meet at a vertex and the vertex is proximate an outer edge of the rear surface. The ribs may extend in a direction oblique to a radial direction of the flange. In one embodiment, the geometric features are formed as a honeycomb pattern.

### BRIEF DESCRIPTION OF THE DRAWINGS

FIG. 1 is a cross-section of a wheel bearing assembly, according to an embodiment;

FIG. 2 is a perspective view of an inner ring and a flange with a plurality of ribs, according to an embodiment;

FIG. 3 is a perspective view of the inner ring and flange of FIG. 2 assembled with an outer ring;

FIG. 4 is a perspective view of an inner ring and a flange with a plurality of ribs, according to an embodiment;

FIG. 5 is a perspective view of the inner ring and flange of FIG. 4 assembled with an outer ring;

FIG. 6 is a perspective view of an inner ring and a flange with a honeycomb pattern, according to an embodiment; and

FIG. 7 is a perspective view of the inner ring and flange of FIG. 6 assembled with an outer ring.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

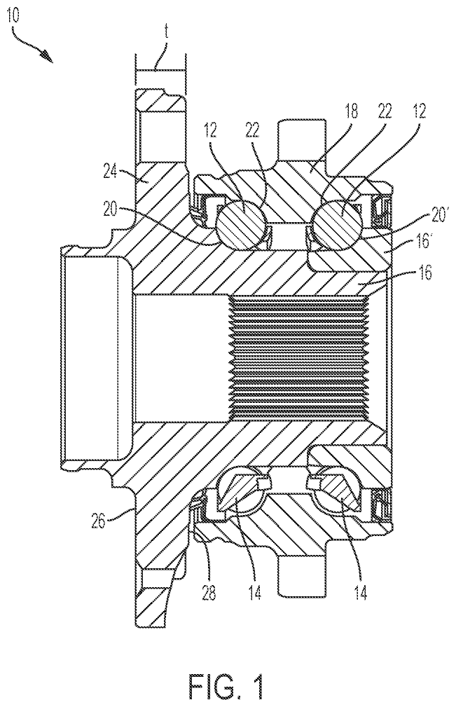

With reference to FIG. 1, a wheel bearing assembly 10 is shown. The wheel bearing assembly 10 may be designed for a vehicle. The wheel bearing assembly 10 may include one or more rolling elements 12, which may include spherical balls, rollers, tapered rollers, barrel-shaped spherical rollers, or others. In the embodiment shown, the wheel bearing assembly 10 includes two sets of rolling elements 12, which may be referred to as a double-row bearing. However, the wheel bearing assembly may include only a single row or it may include multiple rows (e.g., two or more). The rolling elements 12 may be held in place by cages 14.

The wheel bearing assembly 10 may include an inner ring 16 and an outer ring 18. The inner ring 16 may define an inner race 20 and the outer ring 18 may define an outer race 22. In the embodiment shown, the outer ring 18 may define the outer race 22 for both sets of rolling elements 12. The inner ring 16, however, may only directly contact the outer set of rolling elements 12 (i.e., left set, as shown). An inner ring insert 16′ may be supported on the inner ring 16 and may form an inner race 20′ for the inner set of rolling elements 12 (i.e., right set, as shown). However, the embodiment shown is merely one example, and other configurations are contemplated by the present disclosure. For example, the inner ring 16 may form the inner race for both sets of rolling elements or there may be inserts that form the inner race for each set.

The inner ring 16 may be connected to a wheel bearing flange 24. The inner ring 16 and the wheel bearing flange 24 may be integrally connected, such that they are formed as a single component (e.g., without fasteners, adhesives, etc.). If integrally connected, the wheel bearing flange 24 may be defined as (or including) a portion of the inner ring 16 extending/oriented in the radial direction (vertically, as shown). The outer ring 18 may be connected to a wheel carrier or knuckle (not shown) in its installed state. Accordingly, the outer ring 18 may be stationary (e.g., a stator) and the inner ring 16 may be configured to rotate (e.g., a rotor). However, the embodiment shown is merely an example, and the relative rotation may change depending on the bearing application or particular design.

The flange 24 may have a thickness (t), which may be defined as the distance from the front or outer surface 26 to the rear or inner surface 28. In the embodiment shown in FIG. 1, the thickness (t) is substantially uniform. In general, wheel bearings may have stiffness requirements, with higher stiffnesses typically being desired. Accordingly, the flange 24 may be designed with a relatively large thickness in order to provide increased stiffness. However, increasing the thickness of the flange 24 also increases the weight of the wheel bearing assembly. This may negatively impact efforts to reduce overall vehicle weight, for example, to increase fuel economy.

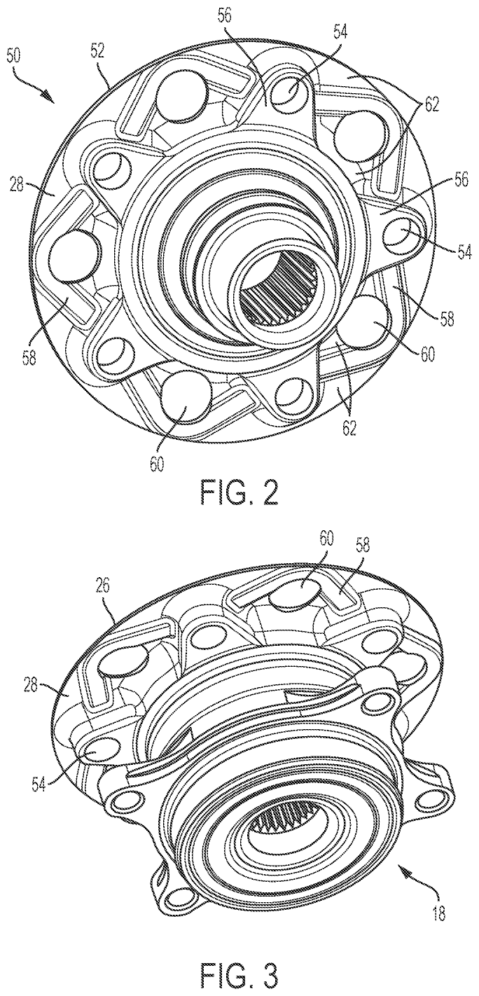

With reference to FIGS. 2-7, several example embodiments are shown of wheel bearing flange designs that may increase (or maintain) stiffness while also reducing weight, thereby meeting stiffness requirements without compromising weight reduction efforts. In general, the flanges include geometric features that increase stiffness. In the regions of the flange between the geometric features, the thickness of the flange may be reduced. Accordingly, the flange may include raised geometric features surrounded by lowered/recessed regions. The geometric features may therefore extend in an axial direction from the rear surface 28, and may do so in a pattern. The pattern may extend over substantially an entire circumference of the rear surface 28 (e.g., except areas occupied by other features, such as thread/stud openings).

With reference to FIGS. 2 and 3, a wheel bearing inner ring 50 is shown. The inner ring 50 may form a wheel bearing assembly with an outer ring, such as shown in wheel assembly 10. The inner ring 50 may be substantially similar to inner ring 16, except that the flange 52 of inner ring 50 may have the geometric features described above. Similar to flange 24, the flange 52 has a front surface 26 and a rear surface 28. The flange 52 may include holes or openings 54 that are configured to receive the wheel bolts/studs. The region 56 of the flange 52 that surrounds the openings 54 may be raised relative to the rest of the flange on the rear surface 28. In this embodiment, the geometric features are in the form of ribs 58, which are located on the rear surface 28. The ribs 58 may be separate from the regions 56 surrounding the openings 54 and the thickness of the flange 52 may refer to the thickness excluding the regions 56. The portions or regions of the flange 52 that do not include the regions 56 or the ribs 58 may be referred to as the recessed or sunken regions 62.

In addition to the ribs 58, the flange 52 may include holes or openings 60. These openings may be solely for weight removal and may not be configured for any other purpose. For example, they may not include any threading to receive a threaded fastener. There may be one or more openings 60 disposed between each opening 54 (e.g., in the circumferential direction).

The ribs 58 may be generally L-shaped or boomerang-shaped, having two legs that meet at a vertex. In the embodiment shown, there is one leg between each opening 54 (e.g., in the circumferential direction), however, in other embodiments there may be two or more legs therebetween. The legs may meet at an angle that is close to perpendicular, but need not be 90 degrees. For example, the legs may meet at an angle of 60 to 120 degrees, 70 to 110 degrees, or 80 to 100 degrees. The vertex may be rounded, such as shown in FIGS. 2 and 3. In one embodiment, the rib 58 may wrap around an opening 60, as shown. The vertex may form a portion of the outer circumference or wall of the opening 60. The vertex may be positioned on or proximate the outer edge of the flange 52. In the embodiment shown, the vertex is located on the outer edge. The legs of the ribs 58 may each abut one of the regions 56 surrounding the openings 54, as shown. In the embodiment shown, the legs of the ribs open inwards towards the center of the flange, however, in another embodiment, the vertex may be radially inward and the legs may open outward. Taken together, the ribs 58 may form a star pattern having as many points as there are openings 54 and/or 60.

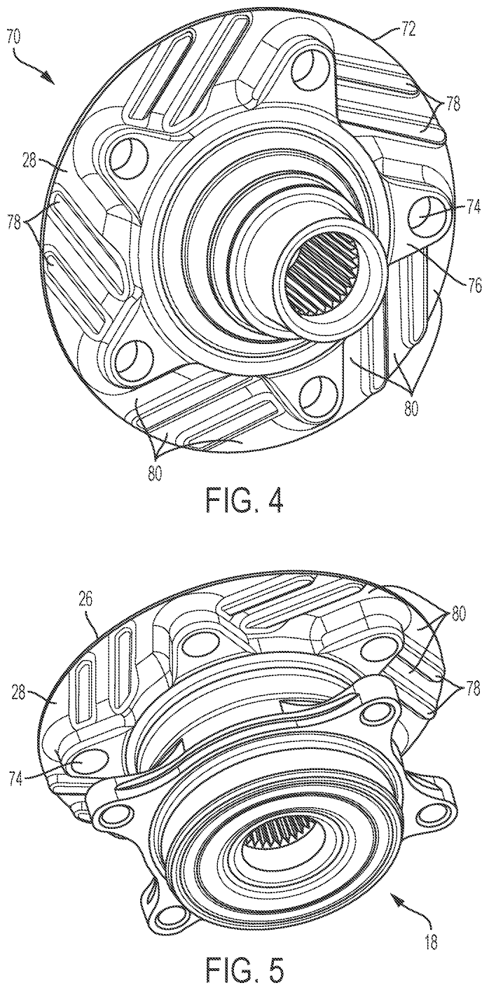

With reference to FIGS. 4 and 5, a wheel bearing inner ring 70 is shown. The inner ring 70 may form a wheel bearing assembly with an outer ring, such as shown in wheel assembly 10. The inner ring 70 may be substantially similar to inner ring 16, except that the flange 72 of inner ring 70 may have the geometric features described above. Similar to flange 24, the flange 72 has a front surface 26 and a rear surface 28. The flange 72 may include holes or openings 74 that are configured to receive the wheel bolts/studs. The region 76 of the flange 72 that surrounds the openings 74 may be raised relative to the rest of the flange on the rear surface 28. In this embodiment, the geometric features are in the form of ribs 78, which are located on the rear surface 28. The ribs 78 may be separate from the regions 76 surrounding the openings 74 and the thickness of the flange 72 may refer to the thickness excluding the regions 76. The portions or regions of the flange 72 that do not include the regions 76 or the ribs 78 may be referred to as the recessed or sunken regions 80. While not shown, the flange 72 may include holes or openings similar to openings 60 shown and described with reference to flange 52.

The ribs 78 may be linear and may extend in a direction that is oblique or at an angle (e.g., non-parallel) to the radial direction of the flange 72. In the embodiment shown, the ribs 78 are straight lines, however, they may be curved or wavy (e.g., triangle wave, sine wave, etc.). There may be one, two, or more ribs 78 disposed between adjacent openings 74. For example, in the embodiment shown there are two ribs 78 between each opening 74. However, it is not necessary for there to be a rib 78 between each set of openings 74. If there are multiple ribs 78 between openings 74, the ribs 78 may be parallel to each other, as shown. The rib(s) 78 may extend on one end to the outer edge of the rear side 28 of flange 72. The other end of the rib(s) 78 may abut a region 76 surrounding an opening 74.

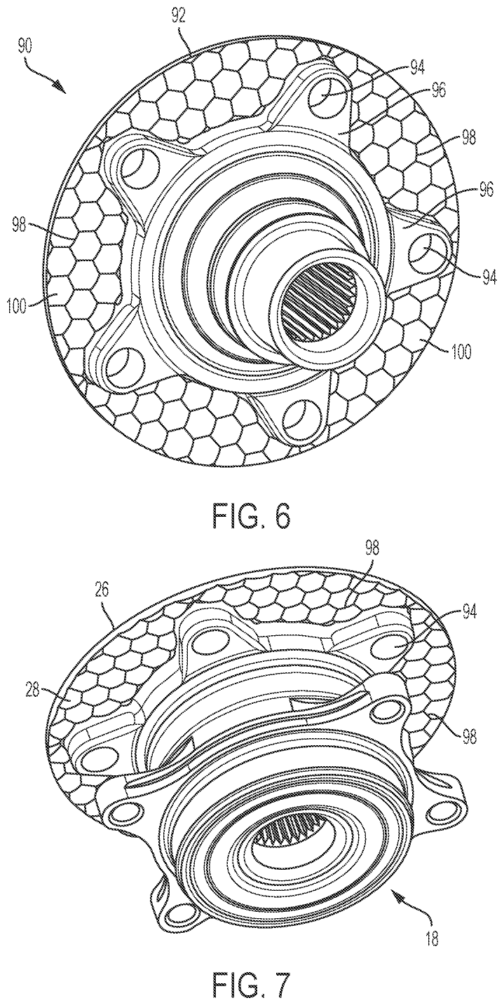

With reference to FIGS. 6 and 7, a wheel bearing inner ring 90 is shown. The inner ring 90 may form a wheel bearing assembly with an outer ring, such as shown in wheel assembly 10. The inner ring 90 may be substantially similar to inner ring 16, except that the flange 92 of inner ring 90 may have the geometric features described above. Similar to flange 24, the flange 92 has a front surface 26 and a rear surface 28. The flange 92 may include holes or openings 94 that are configured to receive the wheel bolts/studs. The region 96 of the flange 92 that surrounds the openings 94 may be raised relative to the rest of the flange on the rear surface 28.

In this embodiment, the geometric features are in the form of a honeycomb structure 98, which is located on the rear surface 28. The honeycomb structure 98 may be separate from the regions 96 surrounding the openings 94 and the thickness of the flange 92 may refer to the thickness excluding the regions 96. The portions or regions of the flange 92 that do not include the regions 96 or the honeycomb structure 98 may be referred to as the recessed or sunken regions 100.

The honeycomb structure 98 may be defined as a hexagonal pattern extending in the axial direction (e.g., perpendicularly out from the rear surface 28). The hexagons in the pattern may be hollow, such that an open space is defined within each hexagon cell. The floor of each cell may be defined by the recessed regions 100. In at least one embodiment, each cell of the honeycomb pattern may have the same floor depth. That is, the recessed regions 100 may all have a same thickness measured relative to the flange front surface 26. However, this is not required, and in some embodiments the cell depth may be different among two or more cells.

While a honeycomb structure 98 is shown having a hexagonal pattern, other patterns may also be used. In one embodiment, the pattern may be a polygonal pattern wherein, instead of hexagons, other shapes are used for the cell structure. For example, the cells could be triangles, quadrilaterals (e.g., squares, trapezoids, etc.), pentagons, octagons, or other polygon shapes. In general, any closed-cell pattern may be used wherein a repeating shape extends in the axial direction to create hollow portions within each cell.

In one embodiment, the geometric features (e.g., ribs 58, ribs 78, or honeycomb 98) may positioned such that any radial line drawn from the center of the flange will cross or intersect a geometric feature and/or a raised region surrounding a wheel bolt/stud opening (e.g., regions 56/76/96 and openings 54/74/94). This may provide stiffness around an entire circumference of the flange and may resist loads perpendicular to the front surface of the flange.

The disclosed geometric features (e.g., ribs 58, ribs 78, or honeycomb 98) may provide stiffness to the wheel bearing flange while the recessed portions reduce the weight. In one embodiment, the geometric features may have a thickness (e.g., distance from front side 26) that is similar to the thickness (t) of flange 24 in FIG. 1. The recessed portions may have a thickness that is significantly smaller than the geometric features. The flange including the geometric features, however, may have a stiffness that is at least similar to the flange 24, while also being significantly lighter.

In one embodiment, the thickness of the geometric features (e.g., ribs 58, ribs 78, or honeycomb 98) may be from 5 to 15 mm, or any sub-range therein, such as 7 to 13 mm or 8 to 12 mm, or about 10 mm (e.g., ±1 mm). The thickness of the recessed regions may be from 0.5 to 5 mm, or any sub-range therein, such as 1 to 4 mm, 1 to 3 mm, or 0.5 to 2 mm. In another embodiment, the recessed regions may have a thickness that is from 1 to 50 percent of the thickness of the geometric features, or any sub-range therein. For example, the recessed regions may be from 1 to 30 percent, 1 to 25 percent, 1 to 20 percent, 1 to 15 percent, 1 to 10 percent, 5 to 25 percent, 5 to 20 percent, or 5 to 15 percent of the thickness of the geometric features.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

wheel bearing assembly 10
rolling elements 12
cages 14
inner ring 16
inner ring insert 16′
outer ring 18
inner race 20
inner race 20′
outer race 22
wheel bearing flange 24
flange front surface 26
flange rear surface 28
wheel bearing inner ring 50
flange 52
openings 54
regions 56
ribs 58
openings 60
sunken regions 62
wheel bearing inner ring 70
flange 72
openings 74
regions 76
ribs 78
sunken regions 80
wheel bearing inner ring 90
flange 92
openings 94
regions 96
honeycomb structure 98
sunken regions 100

What is claimed is:

1. A wheel bearing flange, comprising:
a flange connected to an inner ring of a bearing, the flange having a front surface facing away from the inner ring and a rear surface facing towards the inner ring; and
a plurality of geometric features extending from the rear surface in an axial direction and defining recessed regions of the flange therebetween.

2. The wheel bearing flange of claim 1, wherein the geometric features are formed in a pattern.

3. The wheel bearing flange of claim 1, wherein the recessed regions of the flange have a thickness that is from 1-50% of a thickness of the geometric features.

4. The wheel bearing flange of claim 1, wherein the recessed regions of the flange have a thickness that is from 1-25% of a thickness of the geometric features.

5. The wheel bearing flange of claim 1, wherein the geometric features include ribs.

6. The wheel bearing flange of claim 5, wherein the ribs are formed in a pattern around a circumference of the rear surface.

7. The wheel bearing flange of claim 5, wherein the ribs each include two legs that meet at a vertex.

8. The wheel bearing flange of claim 7, wherein the vertex is proximate an outer edge of the rear surface.

9. The wheel bearing flange of claim 7, wherein the vertex forms a portion of a wall surrounding an opening in the flange.

10. The wheel bearing flange of claim 7, wherein the ribs form a star pattern around a circumference of the rear surface.

11. The wheel bearing flange of claim 5, wherein the ribs extend in a direction oblique to a radial direction of the flange.

12. The wheel bearing flange of claim 5, wherein the flange includes a plurality of spaced apart raised regions having a fastener opening defined therein and one or more ribs are disposed between adjacent raised regions.

13. The wheel bearing flange of claim 12, wherein the one or more ribs extend from a raised region to an outer edge of the rear surface.

14. The wheel bearing flange of claim 1, wherein the geometric features include a repeating polygonal pattern.

15. The wheel bearing flange of claim 14, wherein the repeating polygonal pattern is a honeycomb pattern.

16. A wheel bearing, comprising:
an inner ring configured to connect to a wheel of a vehicle and rotate therewith;
an outer ring configured to connect to the vehicle and remain stationary;
a flange connected to the inner ring, the flange having a front surface facing the wheel and a rear surface facing away from the wheel;
a plurality of rolling elements disposed between the inner and outer rings; and
a plurality of geometric features extending from the rear surface in an axial direction and defining recessed regions of the flange therebetween.

17. The wheel bearing of claim 16, wherein the geometric features include ribs.

18. The wheel bearing of claim 17, wherein the ribs each include two legs that meet at a vertex and the vertex is proximate an outer edge of the rear surface.

19. The wheel bearing of claim 17, wherein the ribs extend in a direction oblique to a radial direction of the flange.

20. The wheel bearing of claim 16, wherein the geometric features are formed as a honeycomb pattern.
